(19) United States
(12) Patent Application Publication
(10) Pub. No.: US 2024/0072666 A1
(43) Pub. Date: Feb. 29, 2024

(54) CHARGER

(71) Applicant: Yazaki Corporation, Tokyo (JP)

(72) Inventors: Noritaka TAGUCHI, Susono-shi (JP); Ryo GONDO, Susono-shi (JP); Daisuke MAEZAKI, Susono-shi (JP); Yoshiya OHNUMA, Nagaoka-shi (JP); Shunsuke TAKUMA, Nagaoka-shi (JP); Shohei KOMEDA, Tokyo (JP)

(73) Assignee: Yazaki Corporation, Tokyo (JP)

(21) Appl. No.: 18/351,066

(22) Filed: Jul. 12, 2023

(30) Foreign Application Priority Data
Aug. 17, 2022 (JP) 2022-130165

(51) Int. Cl. H02M 3/158; H02J 7/02; H02M 1/38; H02M 3/335

(52) U.S. Cl. CPC H02M 3/158; H02J 7/02; H02M 1/385; H02M 3/33573

(57) ABSTRACT

The control of the switches S21 to S28 of the DC/DC converter 120 includes a first mode in which all of the switches S21 to S28 of the DC/DC converter 120 are OFF and a plurality of second modes in which at least one of the switches S21 to S28 of the DC/DC converter 120 is ON, and when switching from the first mode to one of the plurality of second modes, a dead time T_{d} is not provided between the first mode and the one of the plurality of second modes.

### TECHNICAL FIELD

The present invention relates to a charger.

### BACKGROUND

Various insulated single-phase AC/DC converters have been studied as battery chargers for electric vehicles. In general, a circuit configuration including a diode rectifier with a power factor correction (PFC) circuit, a large-capacity capacitor in the DC link section, and a high-frequency isolated DC/DC converter is used as a charger for electric vehicles. The large-capacity capacitor in the DC link section is required to have a capacity sufficient to absorb power ripple from the single-phase AC power supply, and with such a circuit configuration, it has been difficult to reduce the size.

As a compact charger capable of absorbing the ripple of the power, Non-Patent Document 1 discloses a charging circuit including a Dual-Active-Bridge (DAB) converter with an active buffer for absorbing the ripple of the power and also discloses control thereof.

### RELATED ART

### Non-Patent Document

Non-Patent Document 1: Shohei Komeda, Yoshiya Ohnuma, “Dual Active Bridge AC-DC Converter with an Active Energy Buffer”, Papers of Technical Meeting on Semiconductor Power Converter, 2021, SPC-21-003, pp. 13-18

### SUMMARY OF THE INVENTION

### Problem to be Solved by the Invention

A DAB converter contains full-bridge circuits on both the primary and secondary sides. In general, circuits containing full bridge circuits have a dead time during which all switches in a leg containing a switch that is to be switched are in the OFF state before switching from OFF to ON. However, in the control of the charging circuit disclosed in Non-Patent Document 1, if a dead time is provided for all the timings in which the switches of the DAB converter are switched from OFF to ON, distortion occurs in the reactor current and the output current, and the measured value of transmission power becomes smaller than the command value, resulting in a drop in efficiency.

Accordingly, it is an object of the present invention to provide a compact and highly efficient charger capable of absorbing the ripple of the power.

### Solution to Problem

In order to solve the above problems, a charger according to one embodiment of the present invention includes: a rectifier including two input terminals for connection to an alternating-current power supply, a cathode terminal, and an anode terminal; a DC/DC converter including a first terminal connected to the cathode terminal of the rectifier via a first line, a second terminal connected to the anode terminal of the rectifier via a second line, and two output terminals for connection to a battery; a power ripple absorption circuit including a first diode, a second diode, a third diode, an inductor, a capacitor, a first switch, and a second switch; and a control unit configured to control switching of switches of the DC/DC converter, the first switch, and the second switch, wherein the first diode is connected between the inductor of the power ripple absorption circuit and one of the input terminals of the rectifier, the second diode is connected between the inductor and the other of the input terminals of the rectifier, the capacitor and the first switch are connected in series between the first line and the second line, the capacitor being provided on a side of the second line, the third diode is connected between: a line connecting the capacitor and the first switch; and the inductor of the power ripple absorption circuit, the second switch is connected between: the second line; and a line connecting the inductor of the power ripple absorption circuit and the third diode, control of the switching of the DC/DC converter by the control unit includes a first mode in which all of the switches of the DC/DC converter are OFF and a plurality of second modes in which at least one of the switches of the DC/DC converter is ON, and when switching from the first mode to one of the plurality of second modes, the control unit does not provide a dead time between the first mode and the one of the plurality of second modes.

### ADVANTAGEOUS EFFECTS OF THE INVENTION

According to the present invention, a compact and highly efficient charger capable of absorbing the ripple of the power can be provided.

### BRIEF DESCRIPTION OF THE DRAWINGS

FIG. 1 is a diagram illustrating a charger 100 according to an embodiment of the present invention.

FIG. 2 is a graph illustrating a relationship between an instantaneous power pₛ that is output from an alternating-current power supply and an instantaneous power p_{c} that is output from a buffer capacitor Cbuf.

FIG. 3 is a table illustrating the states of respective switches in respective modes.

FIG. 4 is a graph illustrating an operation waveform i_{L} of an inductor L of a DC/DC converter 120 according to the present embodiment and an equivalent square wave thereof (buck sequence).

FIG. 5 is a graph illustrating an example of calculation of a duty cycle for each period according to a conventional control method.

FIG. 6 is a graph illustrating an operation waveform i_{L} of the inductor L of the DC/DC converter 120 according to the present embodiment and an equivalent square wave i_{L}′ thereof (boost sequence I).

FIG. 7 is a table illustrating the states of respective switches in respective modes.

FIG. 8 is a graph illustrating an operation waveform iL i_{L} of the inductor L of the DC/DC converter 120 according to the present embodiment and an equivalent square wave i_{L}′ thereof (boost sequence II).

FIG. 9 is a graph illustrating duty cycles when the charger 100 is operated using three controls, i.e., the buck sequence, the boost sequence I, and the boost sequence II.

FIG. 10 is a graph for explaining a current i_{L} of the inductor L of the DC/DC converter 120 and switching of switches S21 to S28.

FIG. 11 is a graph for explaining an output current I_{dc} in a case where a dead time T_{d} is provided in all of the timings at which the switches S21 to S28 of the DC/DC converter 120 are switched from OFF to ON.

FIG. 12 is a graph for explaining settings of the dead time T_{d} according to the present embodiment.

FIG. 13 is a graph for explaining the output current I_{dc} according to the present embodiment.

FIG. 14 is a graph for explaining a triangle wave and modulation waves m₁ to m₆ for obtaining a waveform with the dead time T_{d} provided for all the timings at which the switches S21 to S28 of the DC/DC converter 120 are switched from OFF to ON.

FIG. 15 is a graph for explaining deformation of the modulation waves m₁ to m₆.

FIG. 16 is a graph for explaining the triangle wave and the modulation waves m₁ to m₆ according to the present embodiment.

FIG. 17 is a graph for explaining the output current I_{dc} when the triangle wave and the modulation waves m₁ to m₆ of FIG. 15 are used.

### DETAILED DESCRIPTION OF THE EXEMPLARY EMBODIMENT

### <Charger 100>

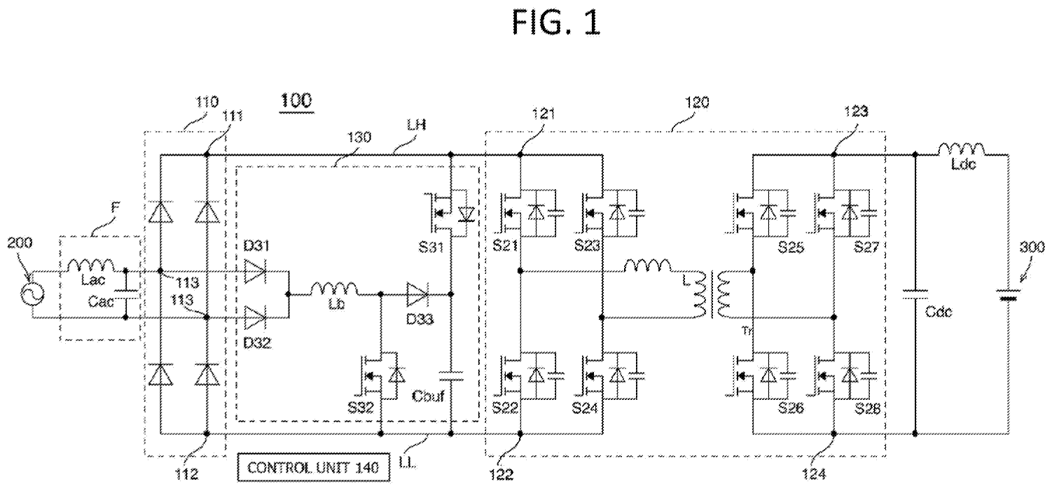

FIG. 1 is a diagram illustrating a charger 100 according to an embodiment of the present invention. The charger 100 includes a rectifier 110, a DC/DC converter 120, a power ripple absorption circuit 130, and a control unit 140. The charger 100 converts a single-phase alternating-current voltage vₛ received from a single-phase alternating-current power supply 200 into a direct-current voltage V_{dc}, and outputs the direct-current voltage V_{dc} to a battery 300.

The rectifier 110 includes: a cathode terminal 111 and an anode terminal 112 connected to the DC/DC converter 120; and two input terminals 113 for connection to the alternating-current power supply 200. For example, as illustrated in FIG. 1, the rectifier 110 is a bridge diode rectifier constituted by four diodes, which converts, into a direct-current current, the alternating-current current that is input across the two input terminals 113 connected to the alternating-current power supply, and outputs the direct-current current from the cathode terminal 111. As illustrated in FIG. 1, the rectifier 110 may be connected to the alternating-current power supply 200 via a filter F including an inductor Lac and a capacitor Cac.

The DC/DC converter 120 is, for example, a dual active bridge (DAB) converter. The DC/DC converter 120 includes a first terminal 121 connected to the cathode terminal 111 of the rectifier 110, a second terminal 122 connected to the anode terminal 112 of the rectifier 110, a third terminal 123 connected to the positive electrode of the battery 300, and a fourth terminal 124 connected to the negative electrode of the battery 300. The DC/DC converter 120 includes: a transformer Tr; a full-bridge circuit including four switches, i.e., a first switch S21, a second switch S22, a third switch S23, and a fourth switch S24, on the input side (primary side); and a full-bridge circuit including four switches, i.e., a fifth switch S25, a sixth switch S26, a seventh switch S27, and an eighth switch S28, on the output side (secondary side). The transformer Tr is interposed between the full-bridge circuit on the input side (primary side) and the full-bridge circuit on the output side (secondary side). Each of the eight the switches S21 to S28 is, for example, an N-channel power metal-oxide-semiconductor field-effect transistor (MOSFET) with an opposite polarity diode (a body diode). In this case, the N-channel power MOSFET may have a snubber capacitor as shown in FIG. 1.

The full-bridge circuit on the primary side of the DC/DC converter 120 includes two legs (i.e., a leg including the first switch S21 and the second switch 22 and a leg including the third switch S23 and the fourth switch S24) connected between the first terminal 121 and the second terminal 122, and the full-bridge circuit on the secondary side of the DC/DC converter 120 includes two legs (i.e., a leg including the fifth switch S25 and the sixth switch 26 and a leg including the seventh switch S27 and the eighth switch S28) connected between the third terminal 123 and the fourth terminal 124.

The DC/DC converter 120 has an inductor L on the primary side of the transformer Tr. The inductor L has, for example, a leakage inductor of the transformer Tr.

Also, a direct-current capacitor Cdc is connected between the third terminal 123 and the fourth terminal 124 of the DC/DC converter 120. An inductor Ldc may be connected between the third terminal 123 of the DC/DC converter 120 and the positive electrode of the battery 300.

The power ripple absorption circuit 130 includes a first diode D31, a second diode D32, a third diode D33, an inductor Lb, a buffer capacitor Cbuf, a first switch S31, and a second switch S32.

The first diode D31 of the power ripple absorption circuit 130 is connected between the inductor Lb of the power ripple absorption circuit 130 and one of the two input terminals 113 of the rectifier 110, and the second diode D32 of the power ripple absorption circuit 130 is connected between the inductor Lb of the power ripple absorption circuit 130 and the other of the two input terminals 113 of the rectifier 110. In this case, the first diode D31 and the second diode D32 of the power ripple absorption circuit 130 are connected between the inductor Lb of the power ripple absorption circuit 130 and the input terminals 113 of the rectifier 110, in such a manner that the forward direction of the first diode D31 and the second diode D32 is the direction from the input terminal 113 of the rectifier 110 to the inductor Lb. Accordingly, even though the alternating-current power supply 200 is connected to the input terminals 113 of the rectifier 110, the inductor Lb of the power ripple absorption circuit 130 receives direct current.

The buffer capacitor Cbuf and the first switch S31 of the power ripple absorption circuit 130 are connected in series between: a first line LH connecting the cathode terminal 111 of the rectifier 110 and the first terminal 121 of the DC/DC converter 120; and a second line LL connecting the anode terminal 112 of the rectifier 110 and the second terminal 122 of the DC/DC converter 120. The buffer capacitor Cbuf is provided on the side of the second line LL, and the first switch 31 is provided on the side of the first line LH. The first switch S31 is, for example, an N-channel power metal-oxide-semiconductor field-effect transistor (MOSFET) with an opposite polarity diode (body diode). In this case, the source of the N-channel power MOSFET may be connected to the first line LH, and the drain of the N-channel power MOSFET may be connected to the buffer capacitor.

The third diode D33 of the power ripple absorption circuit 130 is connected between: a line connecting the buffer capacitor Cbuf and the first switch S31 of the power ripple absorption circuit 130; and the inductor Lb of the power ripple absorption circuit 130, in such a manner that the forward direction of the third diode D33 is the direction from the inductor Lb to this line.

The second switch S32 of the power ripple absorption circuit 130 is connected between the second line LL and a line connecting the inductor Lb and the third diode D33 of the power ripple absorption circuit 130. The second switch S32 is, for example, an N-channel power metal-oxide-semiconductor field-effect transistor (MOSFET) with an opposite polarity diode (body diode). In this case, the drain of the N-channel power MOSFET may be connected to a line connecting the inductor Lb and the third diode D33 of the power ripple absorption circuit 130, and the source of the N-channel power MOSFET may be connected to the second line LL.

The control unit 140 controls switching of the switches S21 to S28 of the DC/DC converter 120 and the switches S31, S32 of the power ripple absorption circuit 130.

Because the power ripple absorption circuit 130 includes the first diode D31, the second diode D32, the third diode D33, the inductor Lb, the buffer capacitor Cbuf, and the second switch S32, the power ripple absorption circuit 130 can function as a power factor correction (PFC) circuit. For this reason, in the present embodiment, control can be performed so that a sine wave voltage vₛ and a sine wave current iₛ as explained below are input from the alternating-current power supply 200 to the charger 100.

[Math 1]

νₛ(t)=\sqrt{2}Vₛsinωₛt

iₛ(t)=\sqrt{2}Iₛsinωₛt

Vₛ denotes the effective value of the power supply voltage, and Iₛ denotes the effective value of the power supply current.

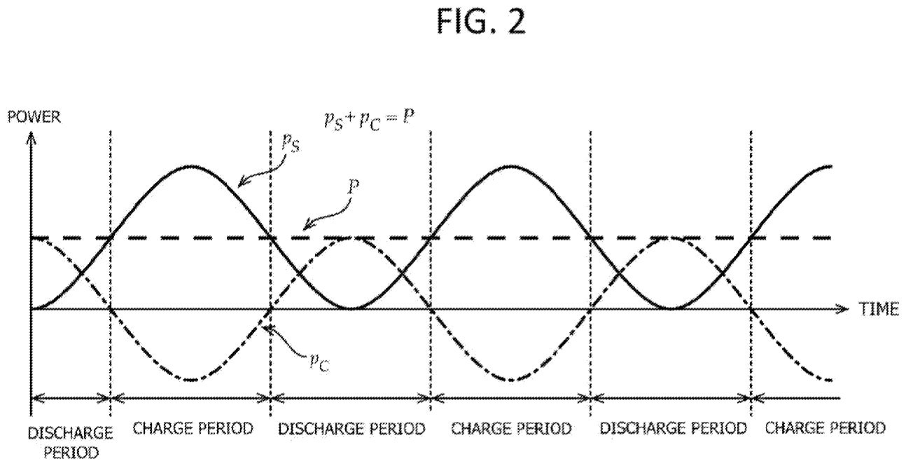

In this case, as indicated below, the instantaneous power pₛ that is output from the alternating-current power supply 200 is a sum of an average power P (=VₛIₛ) and a ripple portion pᵣᵢₚ (t) (=−VₛIₛcos2ωst), and as indicated by a solid line in FIG. 2, and ripples at an angular frequency twice an angular frequency ωS of the alternating current, with respect to the average power P (broken line of FIG. 2).

[Math 2]

pₛ(t)=νₛiₛ=VₛIₛ(1−cos2ωₛt)=P+pᵣᵢₚ(t)

Accordingly, the control unit 140 controls the switches S21 to S28 of the DC/DC converter 120 and the switches S31, S32 of the power ripple absorption circuit 130, so that the power ripple absorption circuit 130 absorbs the ripple of the power from the alternating-current power supply to make the power provided to the DC/DC converter 120 constant.

In this case, the charger 100 according to the present embodiment changes the control between when the instantaneous power pₛ that is output from the alternating-current power supply 200 is higher than the average power P (pₛ>P) and when the instantaneous power pₛ that is output from the alternating-current power supply 200 is lower than the average power P (pₛ<P).

When the instantaneous power pₛ that is output from the alternating-current power supply 200 is higher than the average power P (pₛ>P), switching of the eight switches S21 to S28 of the DC/DC converter 120 and the two switches S31, S32 of the power ripple absorption circuit 130 is controlled, so that the ripple portion pᵣᵢₚ of the instantaneous power pₛ that is output from the alternating-current power supply 200 is charged to the buffer capacitor Cbuf via the inductor Lb of the power ripple absorption circuit 130, and accordingly, only the average power P of the power that is output from the alternating-current power supply is provided to the DC/DC converter 120. In other words, in the present embodiment, the period in which the instantaneous power pₛ that is output from the alternating-current power supply 200 is higher than the average power P is a period (charge period) in which the buffer capacitor Cbuf is charged, and in which the instantaneous power pC that is output from the buffer capacitor Cbuf is negative as indicated by a long dashed short dashed line in FIG. 2.

On the other hand, when the instantaneous power pₛ that is output from the alternating-current power supply 200 is lower than the average power P (pₛ<P), the second switch S32 of the power ripple absorption circuit 130 keeps the OFF state and controls switching of the eight switches S21 to S28 of the DC/DC converter 120 and the first switch S31 of the power ripple absorption circuit 130 to actively discharge the buffer capacitor Cbuf via the first switch S31, so that the ripple portion pᵣᵢₚ that is the difference between the average power P and the instantaneous power pₛ that is output from the alternating-current power supply 200 is compensated for, and accordingly, the average power P is provided to the DC/DC converter 120. In other words, in the present embodiment, the period in which the instantaneous power pₛ that is output from the alternating-current power supply 200 is lower than the average power P is a period (discharge period) in which the buffer capacitor Cbuf is discharged, and in which the instantaneous power pC that is output from the buffer capacitor Cbuf is positive as indicated by the long dashed short dashed line in FIG. 2.

Therefore, in the present embodiment, the control unit 140 controls switching of the switches S21 to S28 of the DC/DC converter 120 and the switches S31 to S32 of the power ripple absorption circuit 130, so that the sum of the instantaneous power pₛ that is output from the alternating-current power supply 200 and the instantaneous power pC that is output from the buffer capacitor Cbuf becomes constant.

In this manner, in the present embodiment, the buffer capacitor Cbuf is actively discharged in the discharge period. For this reason, in the present embodiment, the mount of power accumulated in the buffer capacitor Cbuf (i.e., the capacity of the buffer capacitor Cbuf) can be reduced, and the size of the buffer capacitor Cbuf can be reduced.

Furthermore, in the present embodiment, the second switch S32 is activated only in the charge period. For this reason, in the present embodiment, the mount of power accumulated in the inductor Lb (i.e., the inductance of the inductor Lb) can be reduced, and the size of the inductor Lb can be reduced.

Furthermore, in the present embodiment, the power provided to the DC/DC converter 120 does not have ripple. For this reason, in the present embodiment, the transformer Tr of the DC/DC converter 120 and the direct-current capacitor Cdc can be reduced in size.

As described above, in the present embodiment, the sizes of passive devices such as capacitors, inductors, and transformers can be reduced. Therefore, in the present embodiment, the compact and highly efficient charger capable of absorbing the ripple of the power can be provided.

### <Switching Modes and Operation Waveforms>

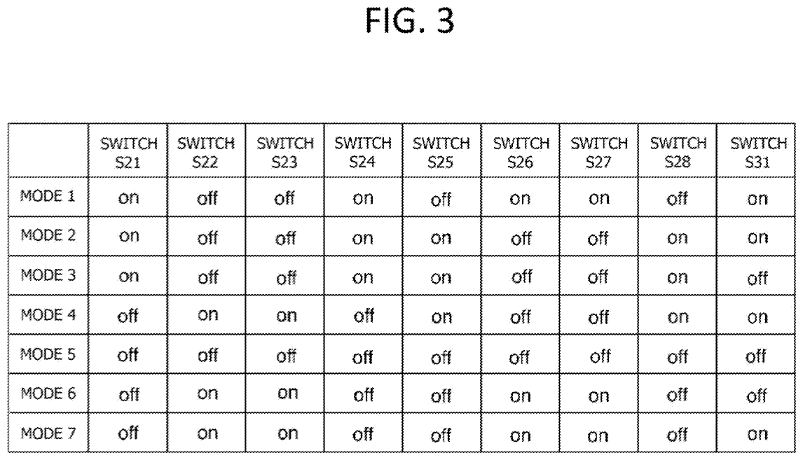

The control unit 140 controls switching of the switches S21 to S28 of the DC/DC converter 120 and the first switch S31 of the power ripple absorption circuit 130 according to seven modes, so that an operation waveform i_{L}, of the inductor L of the DC/DC converter 120 attains an operation waveform that can be approximated by square waveforms. FIG. 3 is a table illustrating the states of respective switches in the seven modes. The seven modes include a mode (mode 5) in which all of the switches S21 to S28 of the DC/DC converter 120 and the first switch S31 of the power ripple absorption circuit 130 are in the OFF state.

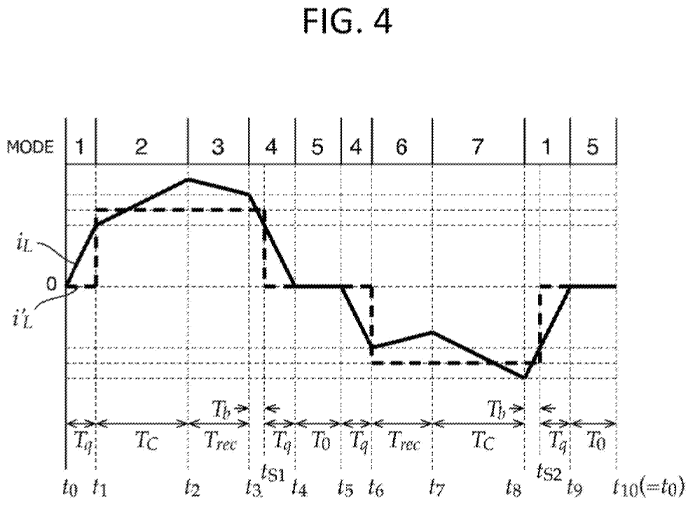

FIG. 4 is a graph illustrating the operation waveform i_{L} of the inductor L of the DC/DC converter 120 according to the present embodiment and an equivalent square wave i_{L′} thereof. This operation waveform i_{L} is obtained by switching the seven modes as illustrated in FIG. 3 in the order of: mode 1, mode 2, mode 3, mode 4, mode 5, mode 4, mode 6, mode 7, mode 1, and mode 5. In this case, the current i_{L} in each of the seven modes is as follows (see Non-Patent Document 1).

$$[ Math 3 ]$$

$${i}_{L} ( t ) = \{ \begin{matrix}\frac{{v}_{C} + {V}_{dc}}{L} ( t - {t}_{c 1} ) + {i}_{L} ( {t}_{c 1} ) & ( MODE 1 ) \\ \frac{{v}_{C} - {V}_{dc}}{L} ( t - {t}_{c 2} ) + {i}_{L} ( {t}_{c 2} ) & ( MODE 2 ) \\ \frac{{v}_{rec} - {V}_{dc}}{L} ( t - {t}_{c 3} ) + {i}_{L} ( {t}_{c 3} ) & ( MODE 3 ) \\ - \frac{{v}_{C} + {V}_{dc}}{L} ( t - {t}_{c 4} ) + {i}_{L} ( {t}_{c 4} ) & ( MODE 4 ) \\ 0 & ( MODE 5 ) \\ - \frac{{v}_{rec} - {V}_{dc}}{L} ( t - {t}_{c 6} ) + {i}_{L} ( {t}_{c 6} ) & ( MODE 6 ) \\ - \frac{{v}_{C} + {V}_{dc}}{L} ( t - {t}_{c 7} ) + {i}_{L} ( {t}_{c 7} ) & ( MODE 7 )\end{matrix} \qquad ( 1 )$$

In this case, t_{cn} (n=1 to 7) denotes a time at which the mode is switched to mode n.

In the present embodiment, in order to actively discharge the buffer capacitor Cbuf when the first switch S31 of the power ripple absorption circuit 130 is in the ON state, the control unit 140 performs control so that the voltage _{vC} applied to the buffer capacitor Cbuf is always greater than the instantaneous voltage v_{rec} that is output from the rectifier 110. Accordingly, in the present embodiment, the voltage v_{C} applied to the buffer capacitor Cbuf has a value different from the instantaneous voltage v_{rec} of the rectifier 110, and the inclination of the operation waveform i_{L} is different between mode 2 and mode 3. Likewise, the inclination of the operation waveform i_{L} is different between mode 6 and mode 7. Therefore, in the present embodiment, as illustrated in FIG. 4, the operation waveform can be generated such that the waveform in the positive region and the waveform in the negative region are asymmetrical about i_{L}=0.

In the operation waveform i_{L} as illustrated in FIG. 4, t₀ to t₁₀ are set such that |t₀−t₁|=|t₅−t₆|, |t₁−t₂|=|t₇−t₈|, |t₂−t₃|=|t₆−t₇|, and |t₃−t₄|=|t₈−t₉|, and t_{S1} is set between t₃ and t₄, and t_{S2} is set between t₈ and t₉ such that |t₀−t₁|=|t_{S1}−t₄|=|t_{S2}−t₉|. In this case, the operation waveform i_{L} can be approximated by the equivalent square waveform i_{L}′.

$$[ Math 4 ]$$

$${i}_{L}^{′} ( t ) = \{ \begin{matrix}\frac{{i}_{L} ( {t}_{1} ) + {i}_{L} ( {t}_{3} )}{2} = {I}_{L}^{′} & ( {t}_{1} \leq t \leq {t}_{S 1} ) \\ - {I}_{L}^{′} & ( {t}_{6} \leq t \leq {t}_{S 2} ) \\ 0 & ( {t}_{0} \leq t < {t}_{1} , {t}_{S 1} < t < {t}_{6} , {t}_{S 2} < t < {t}_{10} )\end{matrix}$$

In the equivalent square waveform i_{L}′, a period at t₀≤t<t₁, t_{S1}≤t<t₄, t₅≤t<t₆, t_{S2}≤t<t₉ is defined as a reactive current period T_{q}, a period at t₁≤t<t₂, t₇≤t<t₈ is defined as a buffer capacitor discharge current period T_{C}, a period at t₂≤t<t₃, t₆≤t<t₇ is defined as a power supply current period T_{rec}, a period at t₃≤t<t_{S1}, t₈≤t<tₛ₂ is defined as a current balance period T_{b}, and a period at t₄≤t<t₅, t₉≤t<t₁₀ is defined as a zero-current period T₀. In this case, the duty cycle of each period in the switching period T_{SW} is as follows.

$$[ Math 5 ]$$

$$\{ \begin{matrix}{D}_{q} & = \frac{2 {T}_{q}}{{T}_{SW}} = \frac{2 {I}_{L}^{′} L}{( {v}_{C} + {V}_{dc} ) {T}_{SW}} - \frac{{D}_{b}}{2} \\ {D}_{C} & = \frac{2 {T}_{C}}{{T}_{SW}} = \frac{{i}_{C}}{{I}_{L}^{′}} + {D}_{b} = \frac{( {v}_{rec} - {V}_{dc} ) {i}_{rec} + ( {v}_{C} + {V}_{dc} ) {i}_{C}}{2 {V}_{dc} {I}_{L}^{′}} \\ {D}_{rec} & = \frac{2 {T}_{rec}}{{T}_{SW}} = \frac{{i}_{rec}}{{I}_{L}^{′}} \\ {D}_{b} & = \frac{2 {T}_{b}}{{T}_{SW}} = \frac{( {v}_{rec} - {V}_{dc} ) {i}_{rec} + ( {v}_{C} - {V}_{dc} ) {i}_{C}}{2 {V}_{dc} {I}_{L}^{′}} \\ {D}_{0} & = \frac{2 {T}_{0}}{{T}_{SW}} = 1 - ( 2 {D}_{q} + {D}_{C} + {D}_{rec} + {D}_{b} )\end{matrix} \qquad ( 2 )$$

The duty cycle of each period can be obtained by giving i_{rec}, v_{C}, V_{dc}, I_{L}′ as command values. The control law for the operation waveform i_{L} of FIG. 4 can be obtained by using the obtained duty cycle of each period. Among the command values, command value i_{rec}*, i_{C}* of i_{rec} and i_{C} are switched between the discharge period and the charge period as follows, so that the power ripple absorption circuit 130 is caused to function as a PFC circuit and circuit for absorbing the ripple of the power.

$$[ Math 6 ]$$

$${i}_{rec}^{⋆} = \{ \begin{matrix}\sqrt{2} \frac{P}{{V}_{S}} \vert sin {ω}_{S} t \vert & ( DISCHARGE PERIOD ) \\ \frac{P}{\sqrt{2} {V}_{S} \vert sin {ω}_{S} t \vert} & ( CHARGE PERIOD )\end{matrix}$$

$${i}_{C}^{⋆} = \{ \begin{matrix}\frac{P}{{v}_{C}} cos {ω}_{S} t & ( DISCHARGE PERIOD ) \\ 0 & ( CHARGE PERIOD )\end{matrix}$$

### <Switching Control During Boost Operation>

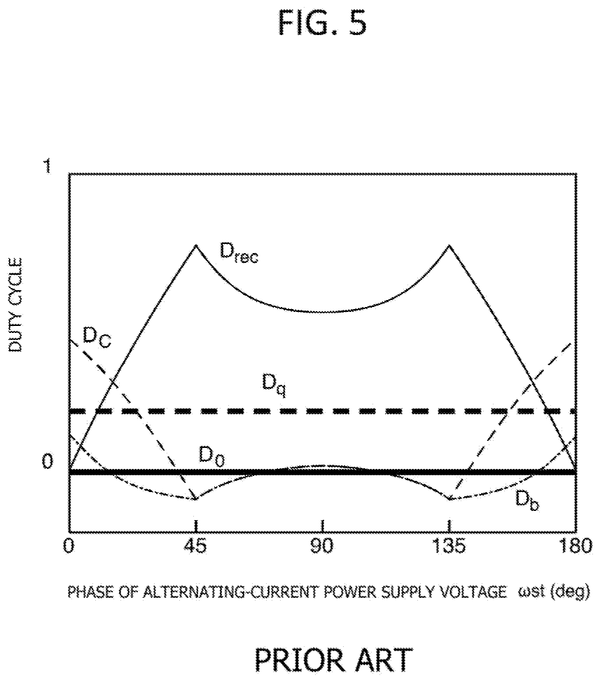

According to the above-described control, in order to operate the charger 100, all of the duty cycles of the above expression (2) are required to be positive. During the buck operation (i.e., V_{S}>V_{dc}), all of the duty cycles of the above expression (2) are positive, but during the boost operation (i.e., V_{S}<V_{dc}), the duty cycle D_{b} of the current balance period T_{b} and the duty cycle D_{C} of the buffer capacitor discharge current period T_{C} may be negative, as illustrated in FIG. 5. In the example as illustrated in FIG. 5, when the phase ωₛₜ of the alternating-current power supply voltage v_{S} is zero degrees, both the duty cycle D_{b} of the current balance period T_{b} and the duty cycle D_{C} of the buffer capacitor discharge current period T_{C} are positive, but when the phase ωₛₜ of the alternating-current power supply voltage v_{S} becomes approximately 15 degrees, the duty cycle D_{b} of the current balance period T_{b} becomes negative, and when the phase ωₛₜ of the alternating-current power supply voltage v_{S} becomes approximately 45 degrees, the duty cycle D_{C} of the buffer capacitor discharge current period T_{C} becomes negative. When the duty cycle D_{b} of the current balance period T_{b} is negative, the following expression can be derived from the above expression (2).

[Math 7]

(ν_{rec}−V_{dc})_{rec}+(ν_{C}−V_{dc})_{C}<0 (3)

When the duty cycle D_{C} of the buffer capacitor discharge current period T_{C} is negative, the following expression holds.

[Math 8]

(ν_{rec}−V_{dc})_{rec}+(ν_{C}+V_{dc})_{C}<0 (4)

Therefore, in the present embodiment, when the duty cycle D_{b} of the current balance period T_{b} becomes negative (i.e., the above expression (3) becomes satisfied), the switching control is changed, and when the duty cycle D_{C} of the buffer capacitor discharge current period T_{C} becomes negative (i.e., the above expression (4) becomes satisfied), the switching control is further changed. Hereinafter, the control that is performed when both the above expression (3) and (4) are not satisfied, i.e., the control explained above, is referred to as a buck sequence, the control that is performed when the above expression (3) is satisfied but the above expression (4) is not satisfied is referred to as a boost sequence I, and the control that is performed when both the above expression (3) and (4) are satisfied is referred to as a boost sequence II.

### (Boost Sequence I)

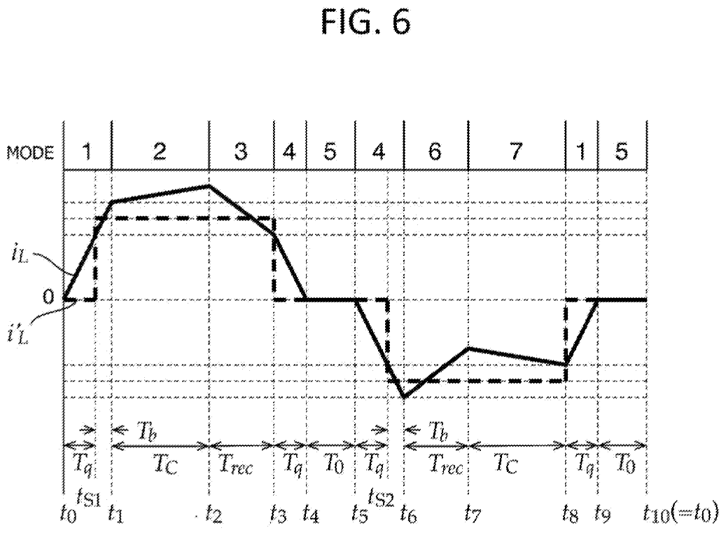

In the operation waveform i_{L} as illustrated in FIG. 4 (the operation waveform during the buck sequence), i_{L} (t₁)≤i_{L} (t₃) holds. However, when the duty cycle D_{b} of the current balance period T_{b} becomes negative (i.e., the above expression (3) becomes satisfied), the operation waveform i_{L} is such that i_{L} (tᵢ)>i_{L} (t₃), as illustrated in FIG. 6. Therefore, in the present embodiment, when the above expression (3) is satisfied, and the above expression (4) is not satisfied, t₀ to t₁₀ are set such that |t₀−t₁|=|t₅−t₆|, |t₁|−t₂|=|t₇−t₈|, |t₂−t₃|=|t₆−t₇|, and |t₃−t₄|=|t₈−t₉|, and t_{S1} is set between t₀ and t₁, and t_{S2} is set between t₅ and t₆, such that |t₀−t_{S1}|=|t₃−t₄|=|t₅−t_{S2}|whereby the operation waveform i_{L} is approximated by the following equivalent square waveform i_{L}′.

$$[ Math 9 ]$$

$${i}_{L}^{′} ( t ) = \{ \begin{matrix}\frac{{i}_{L} ( {t}_{1} ) + {i}_{L} ( {t}_{3} )}{2} = {I}_{L}^{′} & ( {t}_{S 1} \leq t \leq {t}_{3} ) \\ - {I}_{L}^{′} & ( {t}_{S 2} \leq t \leq {t}_{8} ) \\ 0 & ( {t}_{0} \leq t < {t}_{S 1} , {t}_{3} < t < {t}_{S 2} , {t}_{8} < t < {t}_{10} )\end{matrix}$$

In the equivalent square waveform i_{L}′, a period at t₀≤t<t_{S1}, t₃≤t<t₄, t₅≤t<t_{S2}, t₈≤t<t₉ is defined as a reactive current period T_{q}, a period at t₁≤t<t₂, t₇≤t<t₈ is defined as a buffer capacitor discharge current period T_{C}, a period at t₂≤t<t₃, t₆≤t<t₇ is defined as a power supply current period T_{rec}, a period at t_{S1}≤t<t₁, t_{S2}≤t<t₆ is defined as a current balance period T_{b}, and a period at t₄≤t<t₅, t₉≤t<t₁₀ is defined as a zero-current period T₀. In this case, the duty cycle of each period in the switching period T_{SW} is as follows.

$$[ Math 10 ]$$

$$\{ \begin{matrix}{D}_{q} & = \frac{2 {I}_{L}^{′} L}{( {v}_{C} + {V}_{dc} ) {T}_{SW}} - \frac{{D}_{b}}{2} \\ {D}_{C} & = \frac{{i}_{C}}{{I}_{L}^{′}} - {D}_{b} = \frac{( {v}_{rec} - {V}_{dc} ) {i}_{rec} + ( {v}_{C} + {V}_{dc} ) {i}_{C}}{2 {V}_{dc} {I}_{L}^{′}} \\ {D}_{rec} & = \frac{{i}_{rec}}{{I}_{L}^{′}} \\ {D}_{b} & = - \frac{( {v}_{rec} - {V}_{dc} ) {i}_{rec} + ( {v}_{C} - {V}_{dc} ) {i}_{C}}{2 {V}_{dc} {I}_{L}^{′}} \\ {D}_{0} & = 1 - ( 2 {D}_{q} + {D}_{C} + {D}_{rec} + {D}_{b} )\end{matrix} \qquad ( 5 )$$

For the boost sequence I, the duty cycle of each period can also be obtained by giving i_{rec}, i_{C}, vC, V_{dc}, I_{L}′, as command values. By using the duty cycle of each period thus obtained, the control law for the operation waveform i_{L} (boost sequence I) of FIG. 6 can be obtained.

### (Boost Sequence II)

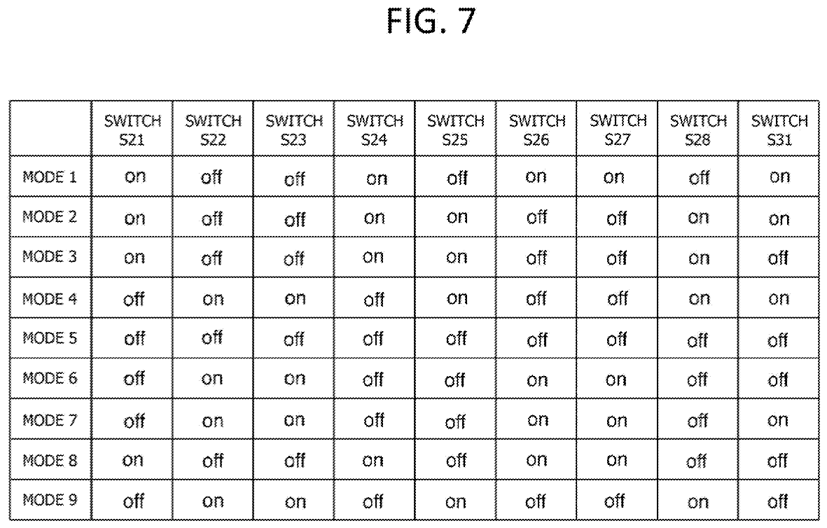

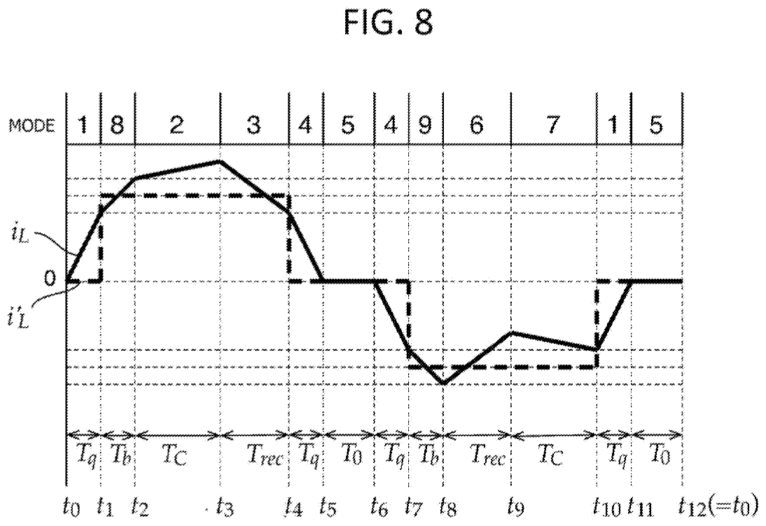

Furthermore, in the present embodiment, when both of the above expressions (3) and (4) are satisfied, switching of the switches S21 to S28 of the DC/DC converter 120 and the first switch S31 of the power ripple absorption circuit 130 is controlled according to nine modes as illustrated in FIG. 7, including not only the seven modes as illustrated in FIG. 3 but also additional two modes. By performing control in this way, the operation waveform i_{L} as illustrated in FIG. 8 is obtained. This operation waveform i_{L} as illustrated in FIG. 8 is obtained by switching the nine modes as illustrated in FIG. 7 in the order of: mode 1, mode 8, mode 2, mode 3, mode 4, mode 5, mode 4, mode 9, mode 6, mode 7, mode 1, and mode 5.

Then, in the operation waveform i_{L} as illustrated in FIGS. 8, t₀ to t₁₂ are set such that |t₀−t₁|=|t₆−t₇|, |t₁−t₂|=|t₇−t₈|, |t₂−t₃|=|t₉−t₁₀|, |t₃−t₄|=|t₈−t₉|, |t₄−t₅|=|t₁₀−t₁₁|, and |t₅−t₆|=|t₁₁−t₁₂|. In this case, the operation waveform i_{L} can be approximated by the equivalent square waveform i_{L}′.

$$[ Math 11 ]$$

$${i}_{L}^{′} ( t ) = \{ \begin{matrix}\frac{{i}_{L} ( {t}_{1} ) + {i}_{L} ( {t}_{4} )}{2} = {I}_{L}^{′} & ( {t}_{1} \leq t \leq {t}_{4} ) \\ - {I}_{L}^{′} & ( {t}_{7} \leq t \leq {t}_{10} ) \\ 0 & ( {t}_{0} \leq t < {t}_{1} , {t}_{4} < t < {t}_{7} , {t}_{10} < t < {t}_{12} )\end{matrix}$$

In the equivalent square waveform i_{L}′, a period at t₀≤t<t₁, t₄≤t<t₅, t₆≤t<t₇, t₁≤t<t₁1 is defined as a reactive current period T_{q}, a period at t₂≤t<t₃, t₉≤t<t₁₀ is defined as a buffer capacitor discharge current period T_{C}, a period at t₃≤t<t₄, t₈≤t<t₉ is defined as a power supply current period T_{rec}, a period at t₁≤t<t₂, t₇≤t<t₈ is defined as a power suppply current period T_{rec}, a period at t₁≤t<t₂, t₇≤t<t₈ is defined as a current balance period T_{b}, and a period at t₅≤t<t₆, t₁₁≤t<t₁₂ is defined as a zero-current period T₀. In this case, the duty cycle of each period in the switching period T_{SW} is as follows

$$[ Math 12 ]$$

$$\{ \begin{matrix}{D}_{q} & = \frac{2 {I}_{L}^{′} L}{( {v}_{C} + {V}_{dc} ) {T}_{SW}} - \frac{{v}_{rec} + {V}_{dc}}{{v}_{C} + {V}_{dc}} \frac{{D}_{b}}{2} \\ {D}_{C} & = \frac{{i}_{C}}{{I}_{L}^{′}} \\ {D}_{rec} & = \frac{{i}_{rec}}{{I}_{L}^{′}} - {D}_{b} = \frac{( {v}_{rec} - {V}_{dc} ) {i}_{rec} + ( {v}_{C} - {V}_{dc} ) {i}_{C}}{2 {V}_{dc} {I}_{L}^{′}} \\ {D}_{b} & = - \frac{( {v}_{rec} - {V}_{dc} ) {i}_{rec} + ( {v}_{C} - {V}_{dc} ) {i}_{C}}{2 {V}_{dc} {I}_{L}^{′}} \\ {D}_{0} & = 1 - ( 2 {D}_{q} + {D}_{C} + {D}_{rec} + {D}_{b} )\end{matrix} \qquad ( 6 )$$

For the boost sequence II, the duty cycle of each period can also be obtained by giving i_{rec}, i_{C}, v_{C}, V_{dc}, I_{L}′, as command values. By using the duty cycle of each period thus obtained, the control law for the operation waveform i_{L} (boost sequence II) of FIG. 8 can be obtained.

### (Operation of Charger 100)

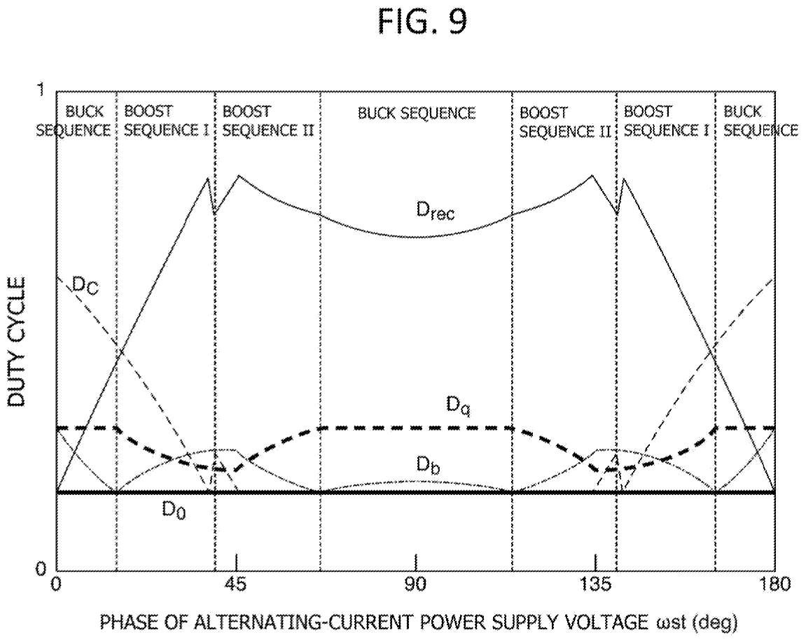

FIG. 9 is a graph illustrating duty cycles when the charger 100 is operated using three controls, i.e., the buck sequence, the boost sequence I, and the boost sequence II. As illustrated in FIG. 9, by changing the switching control in the order of: buck sequence, boost sequence I, boost sequence II, buck sequence, boost sequence II, and boost sequence I, the charger 100 can be operated even during the boost operation.

### <Setting of Dead Time>

The DAB converter includes full-bridge circuits on both the primary side and the secondary side. In general, in a circuit including a full-bridge circuit, when a switch is switched from OFF to ON, a dead time in which all the switches in the leg including the switch that is to be switched are turned OFF is provided in order to prevent all the switches in the same leg from turning ON and shorting the circuit. Therefore, with the charger 100 according to the present embodiment, it is considered to provide, for all of the timings at which the switches S21 to S28 of the DC/DC converter 120 are switched from OFF to ON, a dead time in which all the switches in the leg including the switch that is to be switched are turned OFF.

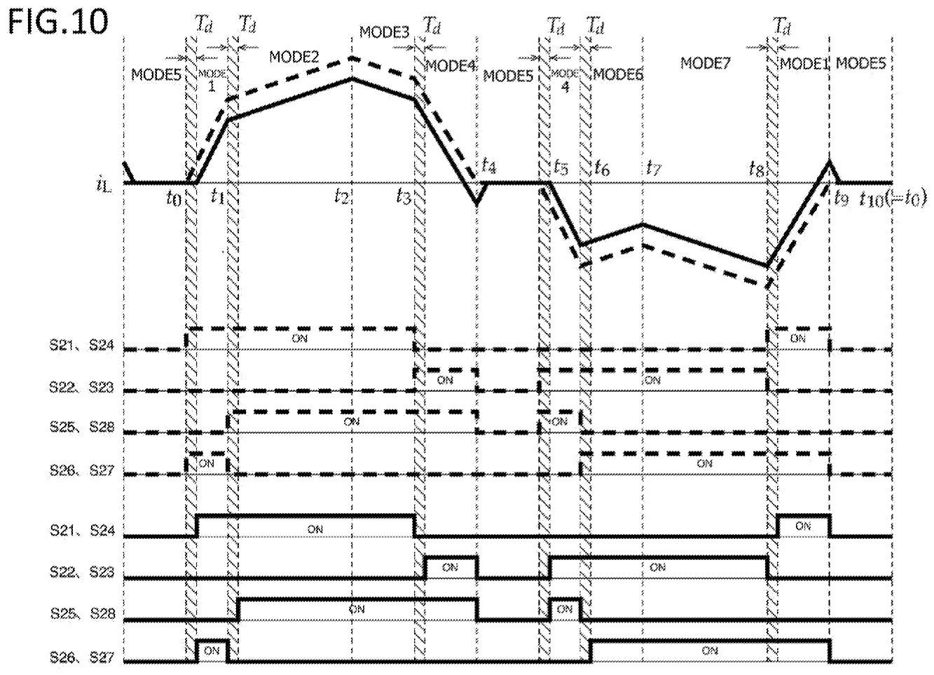

FIG. 10 is a graph for explaining the current i_{L} of the inductor L of the DC/DC converter 120 and switching of the switches S21 to S28. In FIG. 10, a broken line indicates the operation waveform i_{L} during the buck sequence as illustrated in FIG. 4 and switching of the switches S21 to S28 thereof. As illustrated in FIG. 3 (the broken line of FIG. 10), in the operation waveform i_{L} during the buck sequence as illustrated in FIG. 4, when switching from mode 5 to mode 1 (t=t₀), the switches S21, S24, S26, and S27 are switched from OFF to ON; when switching from mode 1 to mode 2 (t=t₁), the switches S25 and S28 are switched from OFF to ON; when switching from mode 3 to mode 4 (t=t₃), the switches S22 and S23 are switched from OFF to ON; when switching from mode 5 to mode 4 (t=t₅), the switches S22, S23, S25, and S28 are switched from OFF to ON; when switching from mode 4 to mode 6 (t=t₆), the switches S26 and S27 are switched from OFF to ON; and when switching from mode 7 to mode 1 (t=t₈), the switches S21 and S24 are switched from OFF to ON.

Therefore, during the buck sequence, as illustrated by a solid line in FIG. 10, it is considered to provide a dead time T_{d} at t=t₀, t₁, t₃, t₅, t₆, and t₈. In other words, it is considered to provide the dead time T_{d} between mode 5 and mode 1, between mode 1 and mode 2, between mode 3 and mode 4, between mode 5 and mode 4, between mode 4 and mode 6, and between mode 7 and mode 1.

As described above, when the dead time T_{d} is provided for all the timings at which the switches S21 to S28 of the DC/DC converter 120 are switched from OFF to ON, the mode 1 starts at t=t₀+T_{d}. In the mode 5 that is immediately before the mode 1, the value of the current i_{L} of the inductor L is zero. Therefore, when the start of the mode 1 delays, the current starts to flow to the inductor L with a delay. As a result, as described above, when the dead time T_{d} is provided for all the timings at which the switches S21 to S28 of the DC/DC converter 120 are switched from OFF to ON, the value of the current i_{L} of the inductor L at the end of the mode 1 (t=t₁) as indicated by the solid line in FIG. 10 is as follows.

$$[ Math 13 ]$$

$${i}_{L} ( {t}_{1} ) = \frac{{v}_{C} + {V}_{dc}}{L} ( {t}_{1} - {t}_{0} - Td )$$

This value is smaller than the value at t=t₁ of the operation waveform i_{L} as illustrated in FIG. 4 (the waveform as indicated by the broken line in FIG. 10), as expressed by the following expression.

$$[ Math 14 ]$$

$${i}_{L} ( {t}_{1} ) = \frac{{v}_{C} + {V}_{dc}}{L} ( {t}_{1} - {t}_{0} )$$

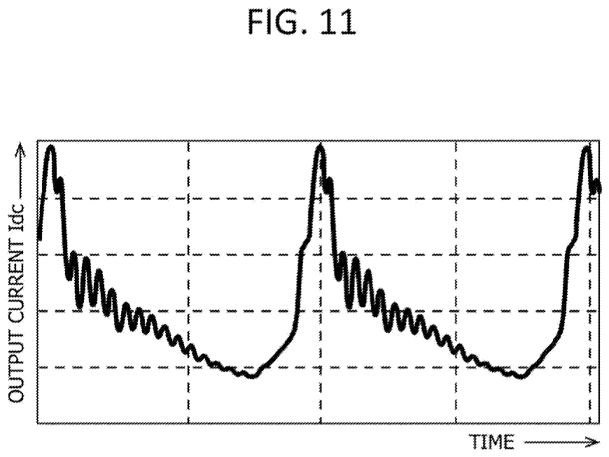

Therefore, in a case where the dead time T_{d} is provided for all the timings at which the switches S21 to S28 of the DC/DC converter 120 are switched from OFF to ON, the waveform of the current i_{L} of the inductor L (waveform as illustrated by a solid line in FIG. 10) has a distorted waveform and is lower in the value of the transmission power, as compared with the waveform without the dead time T_{d} (the waveform as indicated by the broken line in FIG. 10). Furthermore, as described above, in a case where the dead time T_{d} is provided for all the timings at which the switches S21 to S28 of the DC/DC converter 120 are switched from OFF to ON, the distortion of the output current I_{dc} that is output from the third terminal 123 of the DC/DC converter 120 also increases, as illustrated in FIG. 11.

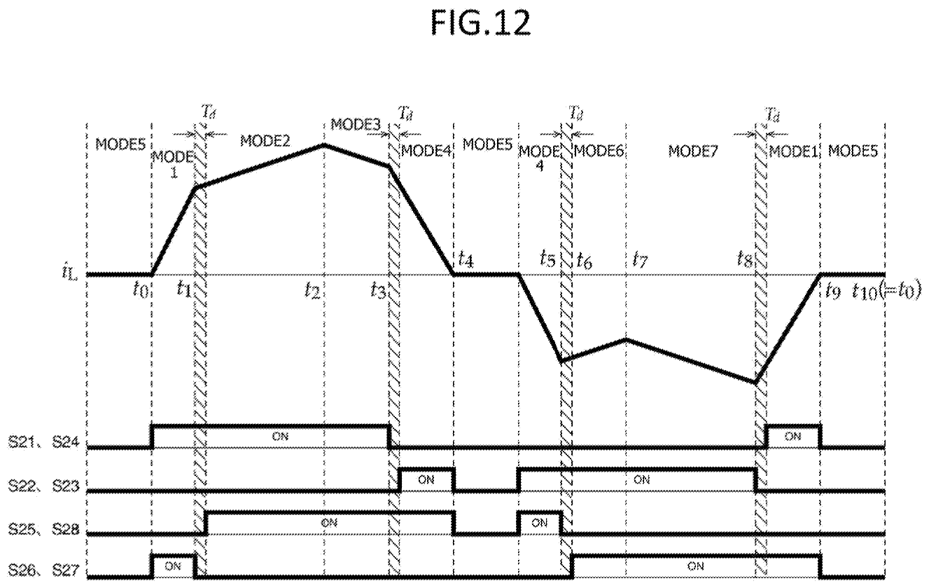

Therefore, in the present embodiment, as indicated by a solid line in FIG. 12, the dead time is not provided at t=t₀, t₅, and the dead time is provided only at t=t₁, t₃, t₆, and t₈. Specifically, in the present embodiment, when the control unit 140 switches between: the first mode (mode 5) in which all of the switches S21 to S28 of the DC/DC converter 120 are in the OFF state; and any one of a plurality of second modes (i.e., mode 1 to mode 4, mode 6, mode 7) in which at least one of the switches S21 to S28 of the DC/DC converter 120 is in the ON state (t=t₀, t₅), the control unit 140 does not provide any dead time between these two modes (i.e., between mode 5 and mode 1 and between mode 5 and mode 4). Furthermore, in a case where any one of the switches S21 to S28 of the DC/DC converter 120 is switched from OFF to ON (t=t₁, t₃, t₆, t₈) when the one of two modes included in the plurality of second modes is switched to the other of the two modes included in the plurality of second modes (t=t₁ to t₃, t₆ to t₈), the control unit 140 provides a dead time between the one of the two modes and the other of the two modes (between mode 1 and mode 2; between mode 3 and mode 4; between mode 4 and mode 6, and between mode 7 and mode 1).

As a result, as illustrated in FIG. 12, the value of the current i_{L} of the inductor L at the end of the mode 1 (t=t₁) becomes as follows.

$$[ Math 15 ]$$

$${i}_{L} ( {t}_{1} ) = \frac{{v}_{C} + {V}_{dc}}{L} ( {t}_{1} - {t}_{0} )$$

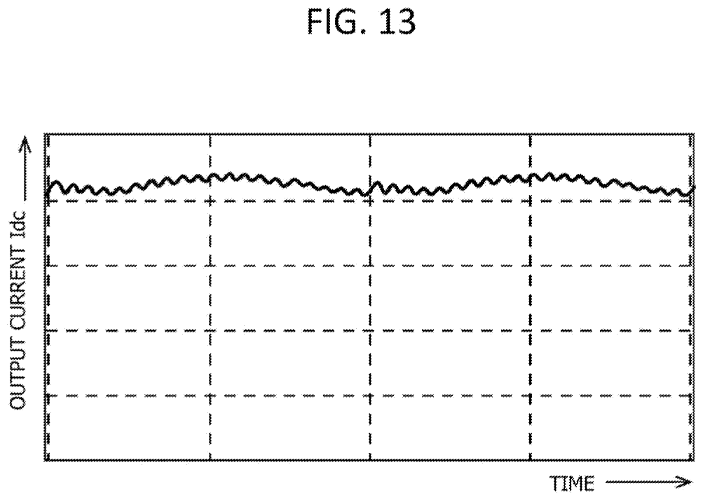

Accordingly, the distortion of the waveform of the current i_{L} of the inductor L is eliminated, and the decrease in the transmission power is also eliminated. Furthermore, as illustrated in FIG. 13, the distortion of the output current I_{dc} is also alleviated.

As explained above, in the present embodiment, the dead time is set so that distortion does not occur in the reactor current and the output current and the transmission power does not decrease. Therefore, in the present embodiment, the compact and highly efficient charger capable of absorbing the ripple of the power can be provided.

In the above explanation, the setting of the dead time has been explained with reference to the example of the buck sequence, but the dead time can be set likewise for the boost sequence I and the boost sequence II, so that distortion does not occur in the reactor current and the output current and the transmission power does not decrease.

In a manner similar to the buck sequence (the waveform of FIG. 4), in the boost sequence I (the waveform of FIG. 6), when the control unit 140 switches between: the first mode (mode 5) in which all of the switches S21 to S28 of the DC/DC converter 120 are in the OFF state; and any one of a plurality of second modes (i.e., mode 1 to mode 4, mode 6, mode 7) in which at least one of the switches S21 to S28 of the DC/DC converter 120 is in the ON state (t=t₀, t₅), the control unit 140 does not provide any dead time between these two modes (i.e., between mode 5 and mode 1 and between mode 5 and mode 4). Furthermore, in a case where any one of the switches S21 to S28 of the DC/DC converter 120 is switched from OFF to ON (t=t₁, t₃, t₆, t₈) when the one of two modes included in the plurality of second modes is switched to the other of the two modes included in the plurality of second modes (t=t₁ to t₃, t₆ to t₈), the control unit 140 provides a dead time between the one of the two modes and the other of the two modes (between mode 1 and mode 2; between mode 3 and mode 4; between mode 4 and mode 6, and between mode 7 and mode 1).

Unlike the buck sequence (the waveform of FIG. 4), in the boost sequence II (the waveform of FIG. 8), the charger 100 is controlled according to nine modes. Therefore, in the boost sequence II (the waveform of FIG. 8), when the control unit 140 switches between: the first mode (mode 5) in which all of the switches S21 to S28 of the DC/DC converter 120 are in the OFF state; and any one of a plurality of second modes (i.e., mode 1 to mode 4, mode 6 to mode 9) in which at least one of the switches S21 to S28 of the DC/DC converter 120 is in the ON state (t=t₀, t₆), the control unit 140 does not provide any dead time between these two modes (i.e., between mode 5 and mode 1 and between mode 5 and mode 4). Furthermore, in a case where any one of the switches S21 to S28 of the DC/DC converter 120 is switched from OFF to ON (t=t₂, t₄, t₈, t₁₀) when the one of two modes included in the plurality of second modes is switched to the other of the two modes included in the plurality of second modes (t=t₁ to t₄, t₇ to t₁₀), the control unit 140 provides a dead time between the one of the two modes and the other of the two modes (between mode 8 and mode 2; between mode 3 and mode 4; between mode 9 and mode 6, and between mode 7 and mode 1).

### <Generation of Control Signal>

The control unit 140 uses a triangle wave comparison method to generate a control signal for controlling switching of, for example, the switches S21 to S28 of the DC/DC converter 120 and the switch S31 of the power ripple absorption circuit 130. In the present embodiment, six modulation waves m₁ to m₆ are used. In the buck sequence, the control unit 140 sets the modulation waves m₁ to m₆ such that in the increasing period at the triangle wave, when the modulation wave m₁ crosses the triangle wave, the zero-current period T₀ ends and the reactive current period T_{q} starts; when the modulation wave m₂ crosses the triangle wave, the reactive current period T_{q} ends and the buffer capacitor discharge current period T_{C} starts; when the modulation wave m₃ crosses the triangle wave, the buffer capacitor discharge current period T_{C} ends and the power supply current period T_{rec} starts; when the modulation wave m₄ crosses the triangle wave, the power supply current period T_{rec} ends and the current balance period T_{b} starts; when the modulation wave m₅ crosses the triangle wave, the current balance period T_{b} ends and the reactive current period T_{q} starts; and when the modulation wave m₆ crosses the triangle wave, the reactive current period T_{q} ends and the zero-current period T₀ starts, and such that in the decreasing period at the triangle wave, when the modulation wave m₆ crosses the triangle wave, the zero-current period T₀ ends and the reactive current period T_{q} starts; when the modulation wave m₅ crosses the triangle wave, the reactive current period T_{q} ends and the power supply current period T_{rec} starts; when the modulation wave m₄ crosses the triangle wave, the power supply current period T_{rec} ends and the buffer capacitor discharge current period T_{C} starts; when the modulation wave m₃ crosses the triangle wave, the buffer capacitor discharge current period T_{C} ends and the current balance period T_{b} starts; when the modulation wave m₂ crosses the triangle wave, the current balance period T_{b} ends and the reactive current period T_{q} starts; and when the modulation wave m₁ crosses the triangle wave, the reactive current period T_{q} ends and the zero-current period T₀ starts.

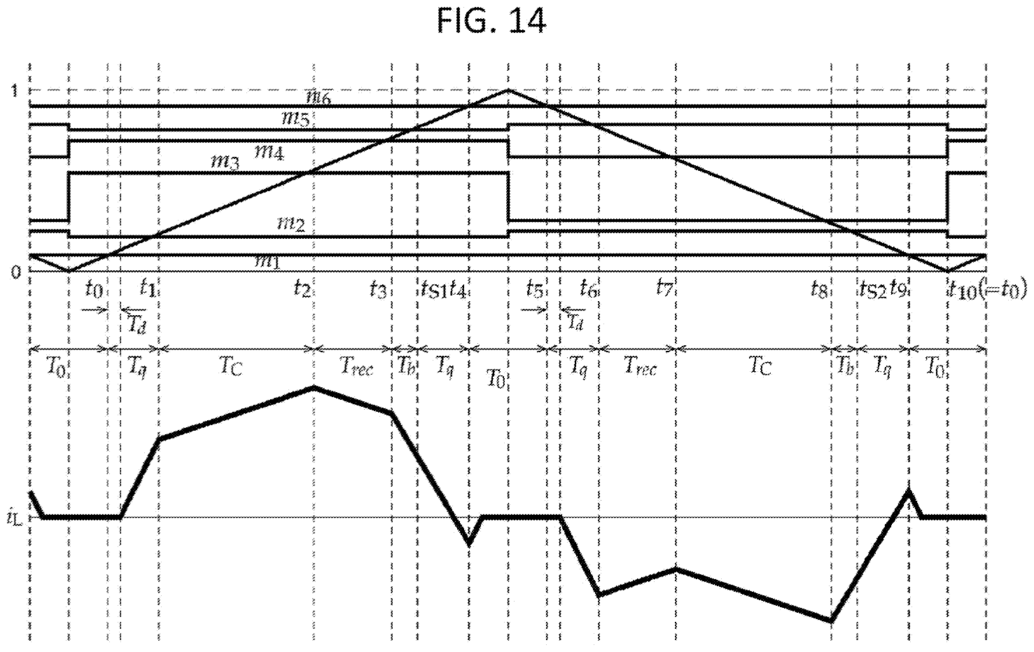

FIG. 14 is a graph for explaining the triangle wave and the modulation waves m₁ to m₆ for obtaining a waveform (the waveform indicated by the solid line in FIG. 10) with the dead time T_{d} provided for all the timings at which the switches S21 to S28 of the DC/DC converter 120 are switched from OFF to ON. In FIG. 14, the triangle wave is set so as to attain the maximum value (=1) in the middle (t=t₄+T₀/2) of the zero-current period T₀ of t₄≤t<t₅, and attain the minimum value (=0) in the middle (t=t₉+T₀/2) of the zero-current period T₀ of t₉≤t<t₁₀. Also, in the increasing period at the triangle wave (t₀−T₀/2≤t<t₄+T₀/2), the inclination of the triangle wave is 2/T_{SW}, the modulation waves m₁ to m₆ are set as follows.

$$[ Math 16 ]$$

$${m}_{1} = \frac{2}{{T}_{SW}} \cdot \frac{{T}_{0}}{2} = \frac{{D}_{0}}{2}$$

$${m}_{2} = {m}_{1} + {D}_{q}$$

$${m}_{3} = {m}_{2} + {D}_{C}$$

$${m}_{4} = {m}_{3} + {D}_{rec}$$

$${m}_{5} = {m}_{4} + {D}_{b}$$

$${m}_{6} = {m}_{5} + {D}_{q} = 1 - \frac{{D}_{0}}{2}$$

In the decreasing period at the triangle wave (t₄+T₀/2≤t<t₉+T₀/2), the inclination of the triangle wave is −2/T_{sw}, and accordingly, the modulation waves m₁ to m₆ are set as follows.

$$[ Math 17 ]$$

$${m}_{6} = 1 - \frac{2}{{T}_{SW}} \cdot \frac{{T}_{0}}{2} = 1 - \frac{{D}_{0}}{2}$$

$${m}_{5} = {m}_{6} - {D}_{q}$$

$${m}_{4} = {m}_{5} - {D}_{rec}$$

$${m}_{3} = {m}_{4} - {D}_{C}$$

$${m}_{2} = {m}_{3} - {D}_{b}$$

$${m}_{1} = {m}_{2} - {D}_{q} = \frac{{D}_{0}}{2}$$

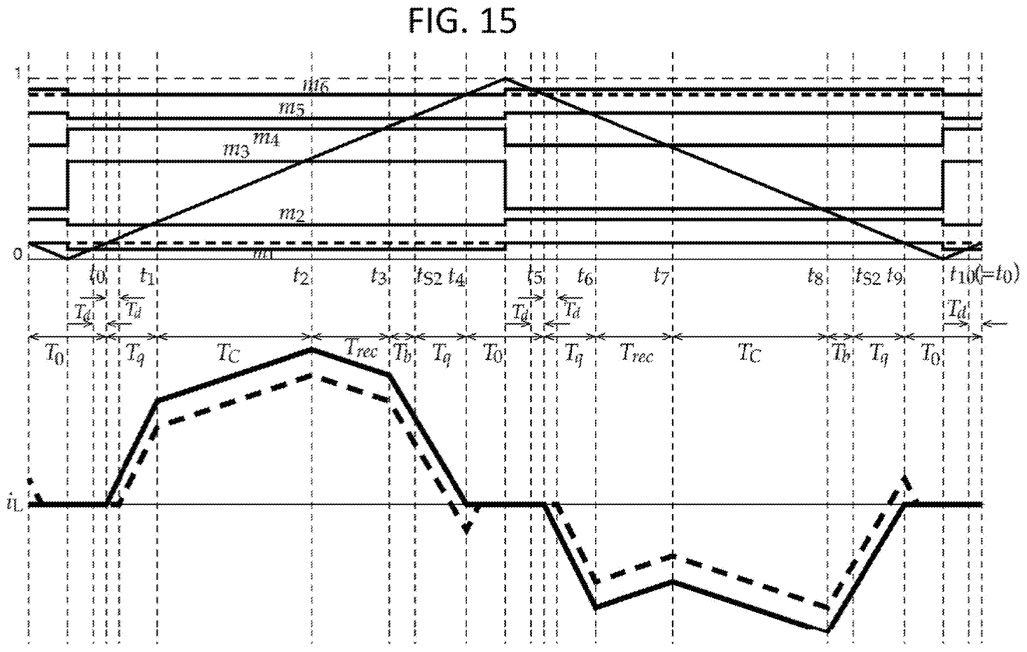

In the waveform without the dead time at t=t₀, t₅ (the waveform of FIG. 12), the timing at which the current starts to flow through the inductor L advances by the dead time T_{d}, as compared with the solid line of FIG. 10. Accordingly, in FIG. 14, the modulation wave m₁ in the increasing period at the triangle wave and the modulation wave m₆ in the decreasing period at the triangle wave are deformed to obtain the modulation waves m₁ to m₆ for obtaining the waveform without the dead time at t=t₀, t₅ (the waveform of FIG. 12). Specifically, as indicated by the solid line in FIG. 15, in the increasing period at the triangle wave, the modulation waves m₁, m₂ are set as follows,

$$[ Math 18 ]$$

$${m}_{1} = \frac{2}{{T}_{SW}} \cdot ( \frac{{T}_{0}}{2} - {T}_{d} ) = \frac{{D}_{0}}{2} - {D}_{td} \qquad ( 7 )$$

$${D}_{td} = \frac{{T}_{d}}{{T}_{SW} / 2}$$

$${m}_{2} = {m}_{1} + {D}_{q 1} + {D}_{td}$$

and in the decreasing period at the triangle wave, the modulation waves m₆, m₅ are set as follows, so that the waveform without the dead time at t=t₀, t₅ (the waveform of FIG. 12) can be obtained.

$$[ Math 19 ]$$

$${m}_{6} = 1 - \frac{2}{{T}_{SW}} \cdot ( \frac{{T}_{0}}{2} - {T}_{d} ) = 1 - \frac{{D}_{0}}{2} + {D}_{td}$$

$${m}_{5} = {m}_{6} - {D}_{q 1} - {D}_{td}$$

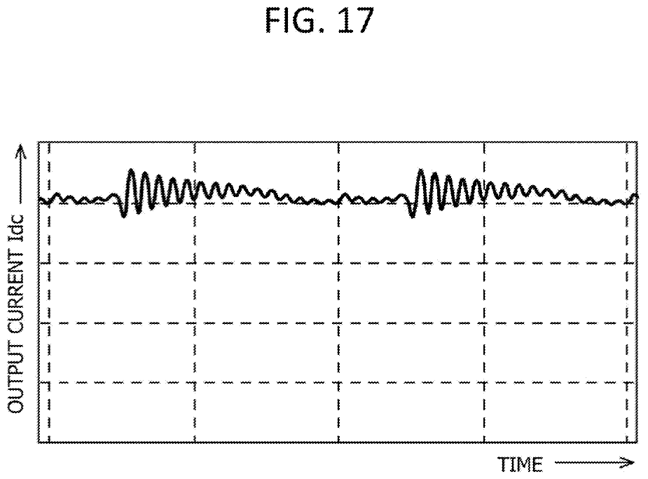

However, as indicated by the solid line of FIG. 15, when the triangle wave and the modulation waves m₁ to m₆ are set, distortion remains in the output current I_{dc} as illustrated in FIG. 17. Furthermore, in order for the modulation wave m₁ to cross the triangle wave, it is necessary to satisfy 0≤m₁≤1. Therefore, based on the above expression (7), the following expression (8) needs to be satisfied.

[Math 20]

D₀≥2D_{td} (8)

The value of the duty cycle D0 of the zero-current period T₀ can be adjusted by appropriately giving the maximum value of the voltage v_{C} applied to the buffer capacitor Cbuf, but in order to satisfy the above expression (8), it is necessary to increase the maximum value of the voltage v_{C} applied to the buffer capacitor Cbuf. Specifically, when the triangle wave illustrated in FIG. 14, 15 is used, it is necessary to increase the maximum value of the voltage v_{C} applied to the buffer capacitor Cbuf.

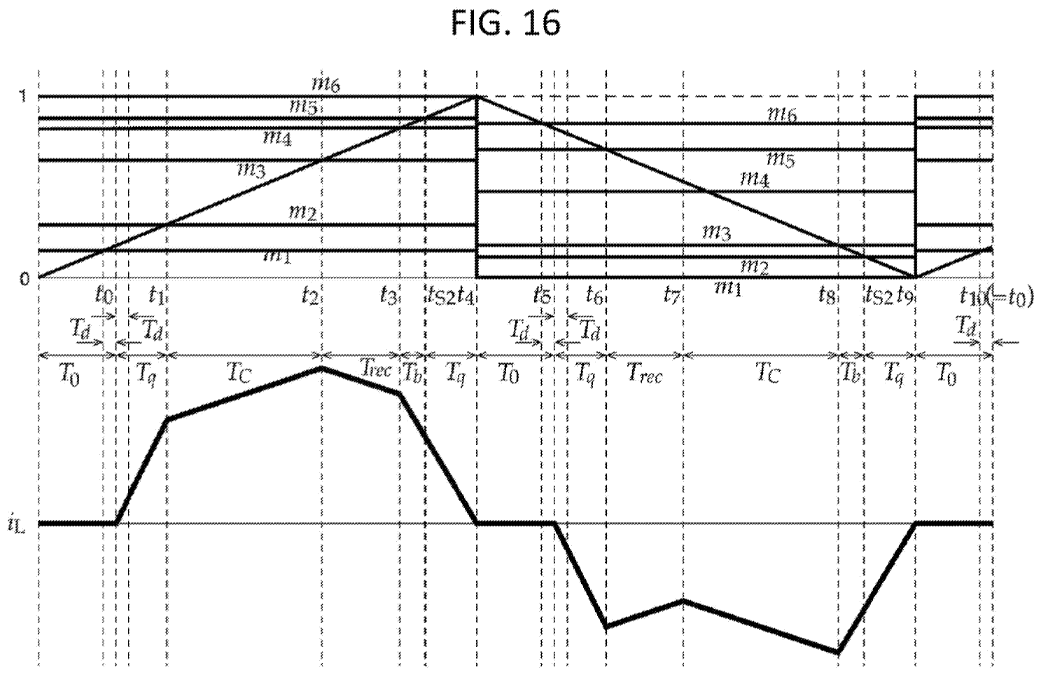

Therefore, in the present embodiment, as illustrated in FIG. 16, the control unit 140 sets the triangle wave to attain the maximum value (for example, 1) or the minimum value (for example, 0) at the start of the first mode (at the start of the mode 5 (t=t₄, t₉)). FIG. 16 is a graph for explaining the triangle wave and the modulation waves m₁ to m₆ according to the present embodiment. In FIG. 16, the triangle wave is set to attain the maximum value (=1) at t=t₄ and attain the minimum value (=0) at t=t₉. In the increasing period at the triangle wave (t₀−T₀/2≤t<t₄+T₀/2), the modulation waves m₁ to m₆ are set as follows.

$$[ Math 21 ]$$

$${m}_{1} = \frac{2}{{T}_{SW}} \cdot ( {T}_{0} - {T}_{d} ) = {D}_{0} - {D}_{td}$$

$${m}_{2} = {m}_{1} + {D}_{q} + {D}_{td}$$

$${m}_{3} = {m}_{2} + {D}_{C}$$

$${m}_{4} = {m}_{3} + {D}_{rec}$$

$${m}_{5} = {m}_{4} + {D}_{b}$$

$${m}_{6} = {m}_{5} + {D}_{q} = 1$$

In the decreasing period at the triangle wave (t₄+T₀/2≤t<t₉+T₀/2), the modulation waves m₁ to m₆ are set as follows.

$$[ Math 22 ]$$

$${m}_{6} = 1 - \frac{2}{{T}_{SW}} \cdot ( {T}_{0} - {T}_{d} ) {T}_{0} = 1 - {D}_{0} + {D}_{td}$$

$${m}_{5} = {m}_{6} - {D}_{q} - {D}_{td}$$

$${m}_{4} = {m}_{5} - {D}_{rec}$$

$${m}_{3} = {m}_{4} - {D}_{C}$$

$${m}_{2} = {m}_{3} - {D}_{b}$$

$${m}_{1} = {m}_{2} - {D}_{q} = 0$$

Furthermore, in order for the modulation wave m₁ to cross the triangle wave, it is necessary to satisfy 0≤m₁≤1. Therefore, it is necessary to satisfy the following expression (9).

[Math 23]

D₀≤D_{td} (9)

In this manner, the triangle wave is set to attain the maximum value or the minimum value at the start of the first mode (at the start of the mode 5), so that, as illustrated in FIG. 13, distortion of the output current I_{dc} is also alleviated. Furthermore, in this manner, the triangle wave is set to attain the maximum value or the minimum value at the start of the first mode (at the start of the mode 5), so that the influence of the dead time T_{d} on the modulation waves m₁ to m₆ is halved as compared with the condition of the expression (8). As a result, the maximum value of the voltage v_{C} applied to the buffer capacitor Cbuf is not required to be increased to the condition of the expression (8).

In the above explanation, the settings of the triangle wave and the modulation wave have been explained with reference to the example of the buck sequence, but the triangle wave and the modulation wave can be set likewise for the boost sequence I and the boost sequence II, so that distortion does not occur in the output current and it is not necessary to increase the maximum value of the voltage applied to the buffer capacitor.

In a manner similar to the buck sequence (the waveform of FIG. 4), in the boost sequence I (the waveform of FIG. 6) and in the boost sequence II (the waveform of FIG. 8), the control unit 140 sets the triangle wave to attain the maximum value (for example, 1) or the minimum value (for example, 0) at the start of the first mode (at the start of the mode 5).

The position of the current balance period T_{b} in the boost sequence I (the waveform of FIG. 6) and in the boost sequence II (the waveform of FIG. 8) is different from the position of the current balance period T_{b} in the buck sequence (the waveform of FIG. 4). Accordingly, in the boost sequence I (the waveform of FIG. 6) and in the boost sequence II (the waveform of FIG. 8), the control unit 140 sets the modulation waves m₁ to m₆ such that in the increasing period at the triangle wave, when the modulation wave m₁ crosses the triangle wave, the zero-current period T₀ ends and the reactive current period T_{q} starts; when the modulation wave m₂ crosses the triangle wave, the reactive current period T_{q} ends and the current balance period T_{b} starts; when the modulation wave m₃ crosses the triangle wave, the current balance period T_{b} ends and the buffer capacitor discharge current period T_{c} starts; when the modulation wave m₄ crosses the triangle wave, the buffer capacitor discharge current period T_{C} ends and the power supply current period T_{rec} starts; when the modulation wave m₅ crosses the triangle wave, the power supply current period T_{rec} ends and the reactive current period T_{q} starts; and when the modulation wave m₆ crosses the triangle wave, the reactive current period T_{q} ends and the zero-current period T₀ starts, and such that in the decreasing period at the triangle wave, when the modulation wave m₆ crosses the triangle wave, the zero-current period T₀ ends and the reactive current period T_{q} starts; when the modulation wave m₅ crosses the triangle wave, the reactive current period T_{q} ends and the current balance period T_{b} starts; when the modulation wave m₄ crosses the triangle wave, the current balance period T_{b} ends and the power supply current period T_{rec} starts; when the modulation wave m₃ crosses the triangle wave, the power supply current period T_{rec} ends and the buffer capacitor discharge current period T_{C} starts; when the modulation wave m₂ crosses the triangle wave, the buffer capacitor discharge current period T_{c} ends and the reactive current period T_{q} starts; and the when modulation wave m₁ crosses the triangle wave, the reactive current period T_{q} ends and the zero-current period T₀ starts.

The present invention has been hereinabove described according to the preferred embodiment of the present invention. Although the present invention has been described with reference to the particular embodiment, various modifications and changes can be made to the embodiment without departing from the spirit and scope of the invention as set forth in the claims.

### LIST OF REFERENCE SIGNS

100 charger
110 rectifier
120 DC/DC converter
S21 to S28 switches of DC/DC converter
130 power ripple absorption circuit
D31 first diode
D32 second diode
D33 third diode
Lb inductor
Cbuf buffer capacitor
S31 first switch
S32 second switch
200 alternating-current power supply
300 battery

What is claimed is:

1. A charger comprising:
a rectifier including two input terminals for connection to an alternating-current power supply, a cathode terminal, and an anode terminal;
a DC/DC converter including a first terminal connected to the cathode terminal of the rectifier via a first line, a second terminal connected to the anode terminal of the rectifier via a second line, and two output terminals for connection to a battery;
a power ripple absorption circuit including a first diode, a second diode, a third diode, an inductor, a capacitor, a first switch, and a second switch; and
a control unit configured to control switching of switches of the DC/DC converter, the first switch, and the second switch,
wherein the first diode is connected between the inductor of the power ripple absorption circuit and one of the input terminals of the rectifier,
the second diode is connected between the inductor and the other of the input terminals of the rectifier,
the capacitor and the first switch are connected in series between the first line and the second line, the capacitor being provided on a side of the second line,
the third diode is connected between: a line connecting the capacitor and the first switch; and the inductor of the power ripple absorption circuit,
the second switch is connected between: the second line; and a line connecting the inductor of the power ripple absorption circuit and the third diode,
control of the switching of the DC/DC converter by the control unit includes a first mode in which all of the switches of the DC/DC converter are OFF and a plurality of second modes in which at least one of the switches of the DC/DC converter is ON, and
when switching from the first mode to one of the plurality of second modes, the control unit does not provide a dead time between the first mode and the one of the plurality of second modes.

2. The charger according to claim 1, wherein when any one of the switches of the DC/DC converter is switched from OFF to ON when switching from one mode of two modes included in the plurality of second modes to the other mode of the two modes included in the plurality of second modes, the control unit provides the dead time between the one of the two modes and the other of the two modes.

3. The charger according to claim 1, wherein the control unit generates a control signal for controlling the switches of the DC/DC converter and the first switch according to a triangle wave comparison method, and
the control unit sets a triangle wave used in the triangle wave comparison method so that the triangle wave attains a maximum value or a minimum value at a start of the first mode.

4. The charger according to claim 1, wherein when a voltage that is output from the alternating-current power supply is boosted, the control unit controls the switches of the DC/DC converter, the first switch, and the second switch, so that a sum of power that is output from the alternating-current power supply and power that is output from the capacitor becomes constant.

5. The charger according to claim 4, wherein the control unit controls the switches of the DC/DC converter, the first switch, and the second switch, so that a voltage applied to the capacitor becomes larger than an output voltage of the rectifier.

6. The charger according to claim 5, wherein in a charge period that is a period in which an instantaneous power that is output from the alternating-current power supply is higher than an average power of the power that is output from the alternating-current power supply, the control unit controls the switches of the DC/DC converter, the first switch, and the second switch, so that a portion of the power that is output from the alternating-current power supply is charged to the capacitor, and
in a discharge period that is a period in which the instantaneous power that is output from the alternating-current power supply is lower than the average power of the power that is output from the alternating-current power supply, the control unit controls the switches of the DC/DC converter, the first switch, and the second switch, so that the power charged in the capacitor is discharged.

7. The charger according to claim 6, wherein the control unit maintains the second switch in an OFF state in the discharge period.

8. The charger according to claim 7, wherein the control unit controls switching of the switches of the DC/DC converter and the first switch, so that an operation waveform of an inductor of the DC/DC converter becomes an operation waveform that can be approximated by a square waveform.

9. The charger according to claim 1, wherein the DC/DC converter is a Dual Active Bridge, DAB, converter.
